(19) United States
(12) Patent Application Publication
(10) Pub. No.: US 2007/0012366 A1
(43) Pub. Date: Jan. 18, 2007

(54) Gripper air switch

(76) Inventors: John Charlton, Tecumseh, MI (US); Keith Price, Clinton, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/485,628

(22) Filed: Jul. 12, 2006

Related U.S. Application Data
(60) Provisional application No. 60/698,394, filed on Jul. 12, 2005.

(51) Int. Cl. F16K 37/00; F16K 11/20

(52) U.S. Cl. 137/553; 137/597

(57) ABSTRACT

A fluid switch system includes a fluid switch having inlets and outlets for fluid flow through the switch. In a first state the inlets are fluidly connected with certain ones of the outlets and in a second state the inlets are fluidly connected with different ones of the outlets.

This patent application claims priority to provisional patent application 60/698,394 filed on Jul. 12, 2005.

### BACKGROUND OF THE INVENTION

This invention relates to pneumatic grippers and, more particularly, to a pneumatic gripper system having a fluid switch near a pneumatic gripper for controlling the pneumatic gripper.

Pneumatic gripper systems are widely known and used in automated systems for gripping and moving work pieces. Conventional pneumatic gripper systems typically include a pair of gripper jaws that are moved between open and closed positions by a pneumatic cylinder. The pneumatic cylinder typically includes two pressurized air input lines. When pressurized air is supplied through one air input line, the gripper jaws open. When pressurized air is supplied through the other air input line, the gripper jaws close.

In conventional pneumatic gripper systems, a main air valve controls the pressurized air supplied to multiple pneumatic grippers. Disadvantageously, during operation of the pneumatic gripper system, one of the pneumatic grippers may become misaligned, loosened, or require adjustment while gripping a work piece. In such a condition, an operator often finds it desirable to readjust the pneumatic gripper in order to desirably grip the work piece. In conventional pneumatic gripper systems, the operator has several options to open and close a selected pneumatic gripper for readjustment. In one option, the operator uses a system control to cut the supply of pressurized air to the pneumatic grippers. This, however, results in the undesirable effect of opening all of the pneumatic grippers, not just the selected pneumatic gripper that needs readjustment. Alternatively, the operator can manually detach and manually switch the air input lines leading into the selected pneumatic gripper. This reverses the position of the gripper jaws such that the operator can adjust the position of the pneumatic gripper on the work piece. Switching the output lines is undesirably time consuming and may damage the air input lines and connections.

The operator may also choose to use the system control to adjust the selected pneumatic gripper. The system control, however, is typically a significant distance away from the work piece and pneumatic grippers. This is time consuming and inconvenient for an operator near the pneumatic grippers.

Accordingly, there is a need for a device that provides a quick and easy means of selectively opening or closing a single pneumatic gripper.

### SUMMARY OF THE INVENTION

An example fluid switch system includes a fluid switch having inlets and outlets for fluid flow there through. In a first state the inlets are fluidly connected with the outlets and in a second state the inlets are fluidly connected with different ones of the outlets.

In another aspect, an example fluid switch system includes a fluid-actuated gripper having gripper jaws and an actuator. The fluid-actuated gripper receives pressurized fluid through a first port to open the gripper jaws or through a second port to close the gripper jaws. A fluid switch near the actuator transmits the pressurized air to a selected one of the first port or second port to open or close the gripper jaws.

In another aspect, an example fluid switch system includes a pressurized fluid source and multiple fluid-actuated grippers each having gripper jaws and an actuator. Each of the fluid-actuated grippers receives pressurized fluid from the pressurized fluid source through a first port to open the gripper jaws or through a second port to close the gripper jaws. One or more fluid switches near the fluid-actuated grippers transmits the pressurized air to a selected one of the first port or second port to selectively open or close the gripper jaws of the one fluid-actuated gripper.

### BRIEF DESCRIPTION OF THE DRAWINGS

FIG. 1 illustrates a schematic view of an example pneumatic gripper assembly.

FIG. 2 illustrates a schematic view of an example pneumatic cylinder.

FIG. 3 illustrates a schematic cross-sectional view of an example fluid switch.

FIG. 4 illustrates a schematic cross-sectional view of the example fluid switch of FIG. 3 in a rotated position.

FIG. 5A illustrates an exploded view of an example fluid switch having a latch.

FIG. 5B illustrates a perspective view of the fluid switch and latch shown in FIG. 5A.

FIG. 6 illustrates a schematic view of a second embodiment of an example fluid switch.

FIG. 7 illustrates a schematic cross-sectional view of the example fluid switch of FIG. 5 in a first position.

FIG. 8 illustrates a schematic cross-sectional view of the example fluid switch of FIG. 5 in a second position.

FIG. 9 illustrates a schematic top view of the example fluid switch of FIG. 5.

### DETAILED DESCRIPTION OF THE PREFERRED EMBODIMENT

FIG. 1 illustrates selected portions of an example pneumatic gripper system 10 that includes a main valve 12. In this example, the main valve 12 receives compressed or pressurized fluid, for example air, from a pressurized fluid source 13. The main valve 12 selectively splits the pressurized air into a first air line 24 and a second air line 26. A controller 28 selectively actuates the main valve 12 to supply pressurized air through either the first air line 24 or second air line 26. The first air line 24 and the second air line 26 extend through a robotic arm 16. The robotic arm 16 includes extended arms 18a, 18b, and 18c coupled to respective pneumatic grippers 20a, 20b, and 20c.

The grippers 20a, 20b, and 20c include respective pneumatic cylinders 30a, 30b, and 30c. The pneumatic cylinders 30a, 30b, and 30c each include ports 31 for receiving pressurized air from the first air line 24 or second air line 26, depending on the position of the main valve 12, to selectively actuate respective rods 32a, 32b, and 32c associated with the pneumatic cylinders 30a, 30b, and 30c. Actuation of the respective rods 32a, 32b, and 32c moves respective gripper jaws 33a, 33b, and 33c on the grippers 20a, 20b, and 20c between an open position and a closed position.

In the illustrated example, a switch 34 is mounted between each of the pneumatic cylinders 30a, 30b, and 30c and the main valve 12. In one example, such as for gripper 20b, the switch 34 is a relatively short distance from the gripper 20b such that an operator can reach the gripper 20b and the switch 34. In another example, such as for gripper 20a, the switch 34 is mounted directly on the gripper 20a. Each switch 34 (i.e., switch system) provides the benefit of switching the first air line 24 and the second air line 26 to selectively open or close any one of the grippers 20a, 20b, or 20c as described below. Given this description, one of ordinary skill in the art will recognize other pneumatically or fluid-actuated machinery that will benefit from the switches 34.

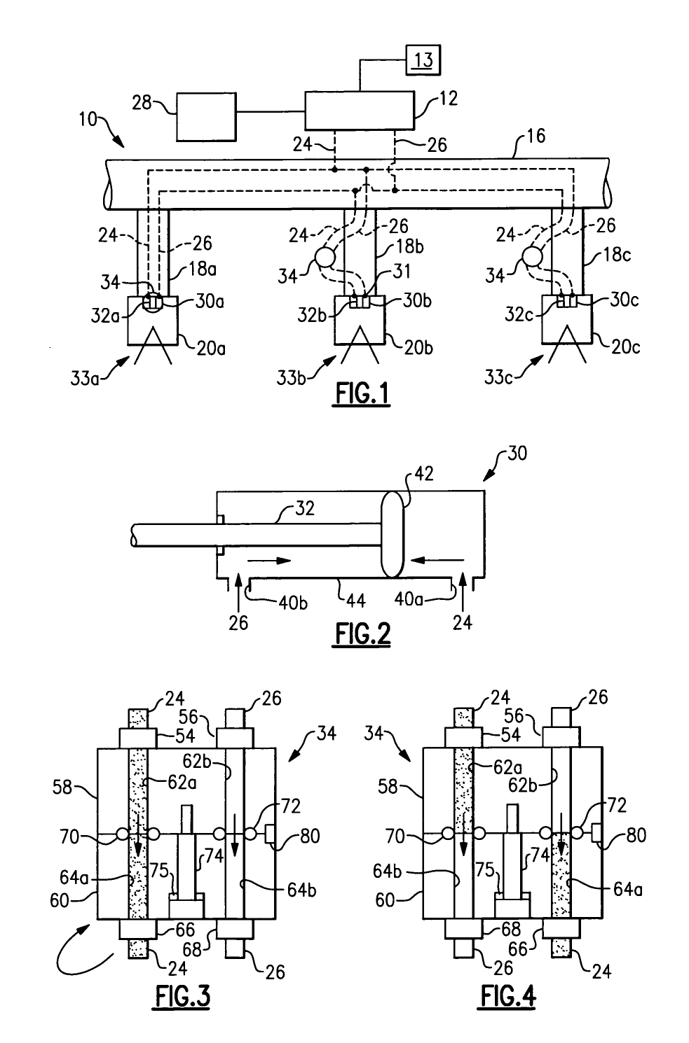

Referring to FIG. 2, an example pneumatic cylinder 30 (e.g., 30a, 30b, and 30c) receives compressed air through either the first air line 24 or the second air line 26. In this example, the pneumatic cylinder 30 includes a first port 40a for receiving the first air line 24 and a second port 40b for receiving the second air line 26. A piston 42 moves within a cylinder housing 44 to actuate the rod 32 (e.g., 32a, 32b, or 32c). When pressurized air is selectively supplied to the first air line 24, the piston 42 moves to the left in the illustration and extends the rod 32 out of the housing 44.

In one example, movement of the rod 32 out of the housing 44 corresponds to opening of the gripper jaws of a pneumatic gripper. When pressurized air is selectively supplied through the second air line 26, the piston 42 moves to the right in the illustration and retracts the rod 32 into the housing 44. In one example, movement of the rod 32 into the housing 44 corresponds to closing the gripper jaws of the pneumatic gripper. Thus, as pressurized air is selectively supplied either through the first air line 24 or the second air line 26, the gripper jaws are selectively opened or closed.

FIG. 3 illustrates one embodiment of an example air switch 34 that receives the first air line 24 and the second air line 26 through respective connectors 54 and 56 (i.e., inlets). In this example, the switch 34 includes a cap 58 coupled to a body 60. The cap 58 is rotationally moveable relative to the body 60. The cap 58 includes a first cap channel 62a fluidly connected to the first air line 24 and a second cap channel 62b fluidly connected to the second air line 26.

The body 60 includes a first body channel 64a fluidly connected to the first cap channel 62a in the illustrated position. A second body channel 64b is fluidly connected to the second cap channel 62b in the illustrated position. Pressurized air flowing through the first body channel 64a and the second body channel 64b leaves the air switch through respective connectors 66 and 68 (i.e., outlets) before exiting through the respective first air line 24 and second air line 26 in the illustrated position to the corresponding one of the pneumatic grippers 20a, 20b, or 20c.

Optionally, the switch 34 includes a first O-ring 70 positioned approximately coaxially with the first cap channel 62a and the first body channel 64a and a second O-ring 72 that is positioned approximately coaxially with the second cap channel 62b and the second body channel 64b. The first O-ring 70 and the second O-ring 72 provide the benefit of a seal between the cap 58 and the body 60 to prevent pressurized air loss.

In this example, a fastener 74 is received through a spring member 75 and through the body 60 into the cap 58 to secure the body 60 and the cap 58 together. The fastener 74 allows relative twisting movement between the cap 58 and the body 60 such that an operator can twist the cap 58 relative to the body 60 to switch the first air line 24 and the second air line 26 as described below.

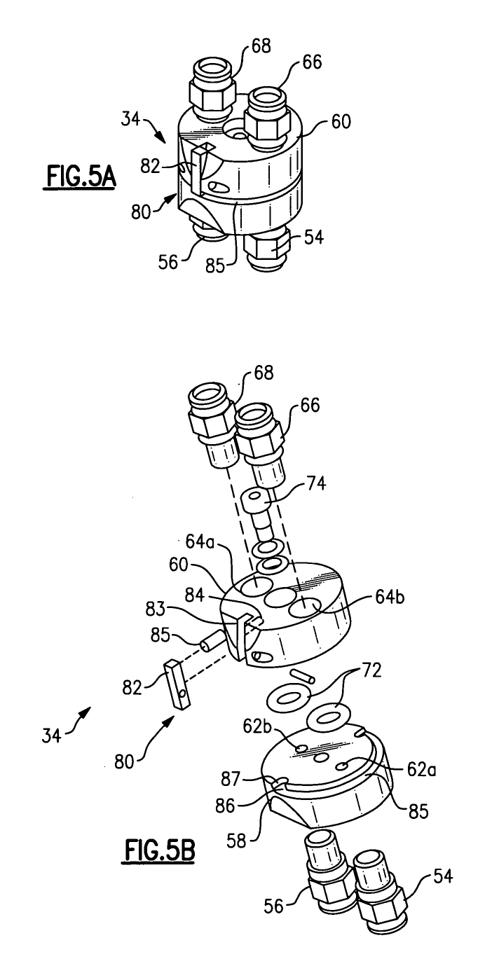

Referring to FIG. 4, an operator has twisted the body 60 about 180° relative to the cap 58. In this position, the first cap channel 62a aligns with the second body channel 64b, and the second cap channel 62b aligns with the first body channel 64a. In the illustrated position, pressurized air flowing into the switch 34 through the first air line 24 will flow through the first cap channel 62a, into the second body channel 64b, and into the second air line 26. Pressurized air that enters the switch 34 through the second air line 26 will flow through the second cap channel 62b, into the first body channel 64a, and into the first air line 24. Thus, pressurized air that was originally flowing through the first air line 24 into the first port 40a of the pneumatic cylinder 30 is switched and flows through the second air line 26 into the second port 40b of the pneumatic cylinder 30 to move the piston 42 and close the gripper jaws.

To switch the first air line 24 and the second air line 26 back to the original position, an operator simply twists the body 60 negative 180° relative to the cap 58 (i.e., in the opposite direction as the operator originally twisted). The air switch 34 therefore provides a simple and quick method of switching the first air line 24 and the second air line 26 to selectively reverse the position of the gripper jaws of the respective grippers 20a, 20b, or 20c without the operator having to travel a significant distance to the controller 28 and without the operator having to manually disconnect the first air line 24 or the second air line 26.

In one example, there is some play between the cap 58 and the body 60 along the axial length of the fastener 74. The spring member 75 biases the cap 58 and the body 60 toward each other to maintain a tight seal. An operator can overcome the bias force of the spring member 75 by pulling the cap 58 and body 60 apart while rotating the cap 58 relative to the body 60. Once in a desired rotational position, the spring member 75 biases the cap 58 and body 60 toward each other to again form a tight seal.

Optionally, the air switch 34 includes a stop 80 between the cap 58 and the body 60. The stop 80 allows the cap 58 to twist about 180° relative to the body 60 and prevents any further rotation. This provides the benefit of simply twisting or untwisting the fully permitted amount without having to fine tune the position of the cap 58 relative to the body 60 to align the cap channels 62a, 62b and body channels 64a, 64b.

Optionally, the first air line 24 and the second air line 26 can be color coded as illustrated by the shading of the first air line 24 in FIGS. 3 and 4. Further, a portion of the cap 58 corresponding to the first cap channel 62a and a position of the body 60 corresponding to the first body channel include an indicator, such as a color indicator, to provide a visual indication of when the first cap channel 62a is aligned with the first body channel 64a. These features provide the benefit of a visual indication of whether the air switch 34 is in a twisted position.

FIGS. 5A and 5B show an embodiment of the switch 34 having a latch 80 for rotatably securing the cap 58 relative to the body 60. In this example, the latch 80 includes a latch pin 82 mounted within a slot 83 in the body 60. The slot includes a blind opening 84 that receives a spring 85. An end of the latch pin 80 travels within a groove 85 on the cap 58. In the disclosed example, the ends of the groove 85 include recessed portions 86 that extend into the cap 59. Given this description, one of ordinary skill in the art will recognize alternative arrangements (e.g., having the slot 83 within the cap 58 and the groove within the body 60) to suit their particular needs.

Operationally, the end of the latch pin 80 travels within the groove 85 as the cap 58 rotates relative to the body 60. The spring 85 urges the latch pin 80 to rotate partially out of the slot 83. When in a rotated position, the corner of the end of the latch pin 82 extends into the recessed portion 86 to prevent the cap 58 from rotating relative to the body 60. To unlock the latch 80, the latch pin 82 is pressed into the slot 83 to overcome the biasing force of the spring 85. The corner of the end of the latch pin 82 retracts out of the recessed portion 86 such that the cap 58 is free to rotate relative to the body 60.

In the illustrated example, the latch pin 82 also provides the function of a stop that allows a desired amount of rotation, 180° in the disclosed example. As depicted in FIG. 5A, the latch pin 82 extends from the bottom of the slot 83 into the groove 85. A wall 87 that forms the recessed portion 86 (likewise on each recessed portion 86) of the groove 85 contacts the end of the latch pin 82 upon rotation to prevent further rotation.

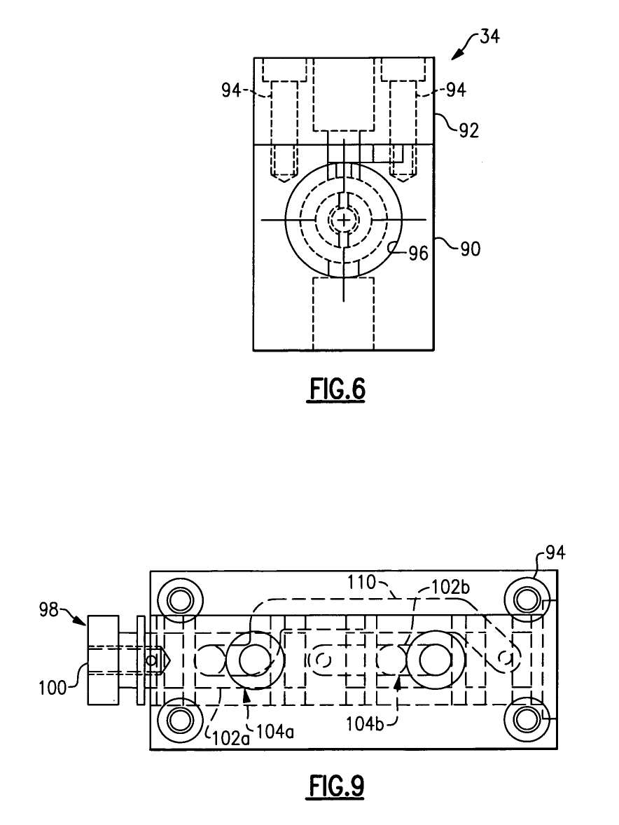

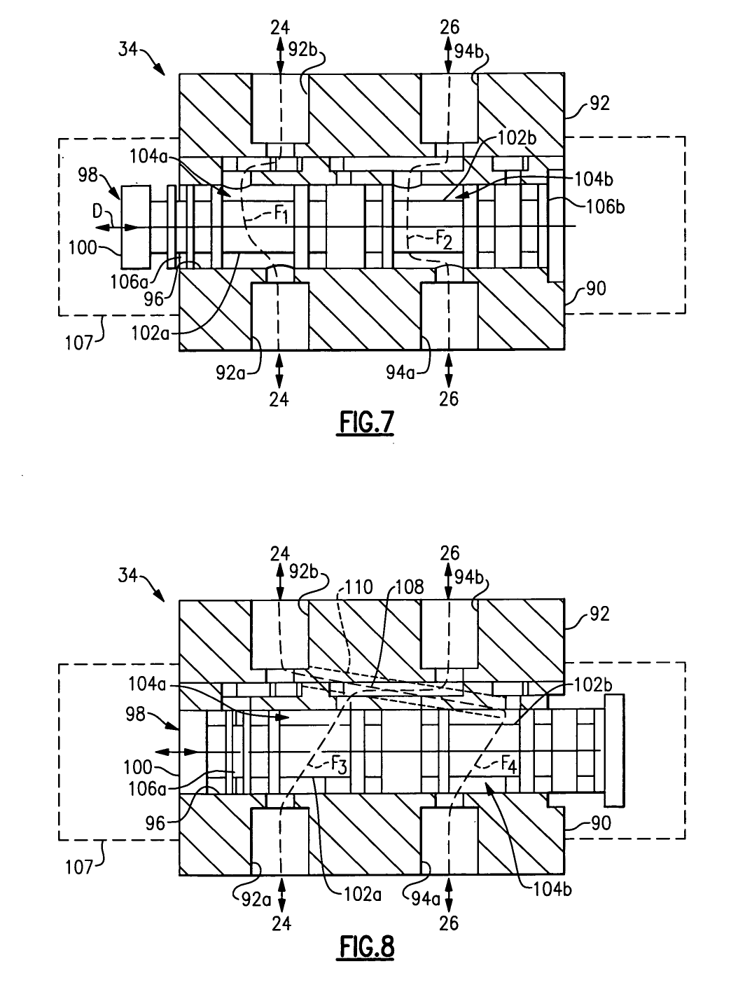

FIGS. 6 and 7 illustrate a second embodiment of the air switch 34 including a body 90 and a manifold 92. The body 90 and manifold 92 are secured together with fasteners 94. The body 90 includes a first inlet 92a and a second inlet 94a that correspond, respectively, to the first air line 24 and the second air line 26. The manifold 92 includes a first outlet 92b and a second outlet 94b that correspond, respectively, to the first air line 24 and the second air line 26.

In the illustrated example, the body 90 includes a bore 96, which receives a switching member 98. The switching member 98 includes a switch rod 100 having a first narrow section 102a and a second narrow section 102b for allowing pressurized air flow between the first inlet 92a, second inlet 92, first outlet 92b, and second outlet 94b as described below. The switch rod 100 is moveable back and forth along a direction D to selectively switch the pressurized air flow between the first air line 24 and the second air line 26.

In the illustrated position, pressurized air is permitted to flow through the first air line 24 between the first inlet 92a and the first outlet 92b along flow path F₁ through a first space 104a defined by the first narrow section 102a and the bore 96. Air is also permitted to flow through the second air line 26 between the second inlet 94a and the second outlet 94b along flow path F₂ through a second space 104b defined by the second narrow section 102b and the bore 96.

Preferably, a first o-ring 106a and a second o-ring 106b are received on opposing ends of the switch rod 100 to seal the flow of pressurized air through the first space 104a and second space 104b.

Referring to FIG. 8, the switch rod 100 has been moved to switch the pressurized air flow through the air switch 34. In the disclosed example, an operator manually pushes the switch rod 100 to move it. Optionally, the air switch 34 includes an actuator 107 that moves the switch rod 100 in response to, for example, pushing a button.

In the illustrated position, the flow paths are switched such that pressurized air flowing from the first air line 24 in through the first inlet 92a flows out through the second outlet 94b to the second air line 26. Alternatively (depending on the selected state of the main valve 12), air flowing in through the second inlet 94a from the second air line 26 exits through the first outlet 92b into the first air line 24.

A flow path F₃ allows the pressurized air to flow between the first inlet 92a and the second outlet 94b through the first space 104a and through a first switch channel 108. A flow path F₄ allows the pressurized air to flow between the second inlet 94a and the first outlet 92b through the second space 104b and through a second switch channel 110 (see FIG. 9). Thus, when the switch rod 100 is moved from the position shown in FIG. 6 to the position shown in FIG. 7, the pressurized air flow through the pneumatic cylinder 30 is reversed and the position of the gripper jaws reverses (e.g., from closed to open or from open to closed depending on the state of the main valve 12).

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A fluid switch system comprising:
a fluid switch having inlets and outlets for fluid flow there through, wherein in a first state the inlets are fluidly connected with respective ones of the outlets and in a second state the inlets are fluidly connected with different ones of the outlets.

2. The fluid switch system as recited in claim 1, further including a first member and a second member each having a plurality of channels there through that fluidly connect the inlets and the outlets, wherein the first member is rotatable relative to the second member to provide the first state and the second state.

3. The fluid switch system as recited in claim 2, further including a fastener that rotatably attaches the first member and the second member together.

4. The fluid switch system as recited in claim 2, wherein the fluid switch includes an indicator for indicating relative rotational position between the first member and the second member.

5. The fluid switch system as recited in claim 4, further including spring member between the fastener and at least one of the first member or the second member.

6. The fluid switch system as recited in claim 2, further including a plurality of seals between the first member and the second member.

7. The fluid switch system as recited in claim 2, further including a stop that resists rotation of the first member relative to the second member beyond a threshold.

8. The fluid switch system as recited in claim 2, further comprising a latch pin mounted on the first member, the latch pin having an end that travels within a groove in the second member as the first member rotates relative to the second member.

9. The fluid switch system as recited in claim 8, further comprising bias member that urges the latch pin toward the groove.

10. The fluid switch system as recited in claim 9, wherein the groove includes a recessed portion such that the bias member urges the end of the latch pin into the recessed portion to resist rotation of the first member relative to the second member.

11. The fluid switch system as recited in claim 1, wherein the fluid switch includes a bore that fluidly connects the inlets and the outlets and a switching member that is moveable within the bore relative to the inlets and the outlets to provide the first state and the second state.

12. The fluid switch system as recited in claim 11, wherein the switching member comprises a cylindrical rod having blocking section that separates two switching sections, wherein the blocking section has an outer diameter and the two switching sections have a nominal diameter that is less than the outer diameter.

13. The fluid switch system as recited in claim 12, wherein in the first state the blocking section prevents fluid connection between the inlets and the different ones of the outlets.

14. The fluid switch system as recited in claim 13, wherein in the second state the blocking section prevents fluid connection between the inlets and the respective ones of the outlets.

15. A fluid switch system comprising:
a fluid-actuated gripper having gripper jaws and an actuator for receiving pressurized fluid through a first port to open the gripper jaws or through a second port to close the gripper jaws; and
a fluid switch near the actuator for transmitting the pressurized air to a selected one of the first port or second port to selectively open or close the gripper jaws.

16. The fluid switch system as recited in claim 15, wherein the fluid switch is mounted directly on the fluid-actuated gripper.

17. The fluid switch system as recited in claim 15, wherein the fluid switch comprises a manually adjustable fluid switch.

18. The fluid switch system as recited in claim 15, wherein the fluid switch comprises an actuator for automatically switching the fluid switch.

19. A fluid switch system comprising:
a pressurized fluid source;
a plurality of fluid-actuated grippers each having gripper jaws and an actuator for receiving pressurized fluid from the pressurized fluid source through a first port to open the gripper jaws or through a second port to close the gripper jaws; and
at least one fluid switch near at least one of the plurality of fluid-actuated grippers for transmitting the pressurized air to a selected one of the first port or second port to selectively open or close the gripper jaws of the one fluid-actuated gripper.

20. The fluid switch system as recited in claim 19, further comprising a valve for selectively providing pressurized fluid from the fluid source to the plurality of fluid-actuated grippers.

21. The fluid switch system as recited in claim 20, further comprising a controller in communication with the valve.

22. The fluid switch system as recited in claim 21, wherein the at least one fluid switch comprises a fluid switch near each one of the plurality of fluid actuated grippers.

23. The fluid switch system as recited in claim 19, further comprising fluid supply lines that connect the plurality of fluid-actuated grippers in parallel to the pressurized fluid source.
